(19) United States
(12) Patent Application Publication
(10) Pub. No.: US 2003/0170044 A1
(43) Pub. Date: Sep. 11, 2003

(54) Developing device, process cartridge and electrophotographic image forming apparatus

(75) Inventors: Takahito Ueno, Shizuoka (JP); Kazunari Murayama, Shizuoka (JP); Nobuharu Hoshi, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/347,871

(22) Filed: Jan. 22, 2003

(30) Foreign Application Priority Data
Jan. 24, 2002 (JP) 2002-015791(PAT.)

(51) Int. Cl. G03G 15/08

(52) U.S. Cl. 399/103

(57) ABSTRACT

The present invention relates to a developing device which includes a developing member for developing the latent image, an exposure optical path, a developer containing portion, a vent port for allowing air in the inside of the developer containing portion to pass therethrough, a first sheet member for preventing scattering of the developer into the exposure optical path, disposed between the exposure optical path and the developing member and contacted with an electrophotographic photosensitive member, a first sealing member for preventing leaking of the developer from the developer containing portion, contacted with one end portion of the electrophotographic photosensitive member in the longitudinal direction of its, and a second sealing member for preventing leaking of the developer from the developer containing portion, contacted with another end portion of the electrophotographic photosensitive member in the longitudinal direction of its.

### BACKGROUND OF THE INVENTION

1. Field of the Invention

The present invention relates to a developing device or a process cartridge which is used in an electrophotographic image forming apparatus such as an electrophotographic copier, an electrophotographic printer or the like, and an electrophotographic image forming apparatus which uses the developing device or the process cartridge, for example.

Here, the electrophotographic image forming apparatus forms an image on a recording medium using an electrophotographic image forming process. Examples of electrophotographic image forming apparatus include an electrophotographic copier, an electrophotographic printer (a LED printer, a laser beam printer or the like), an electrophotographic facsimile device, an electrophotographic word processor and the like.

Here, the process cartridge is an assembled body by integrally forming at least a developing means and an electrophotographic photosensitive member into a cartridge and this cartridge can be replaceably mounted on or dismounted from an image forming apparatus body.

2. Description of the Related Art

Conventionally, there has been adopted a process cartridge system in which a photosensitive drum, charging means, developing means, cleaning means and the like are integrally formed into a cartridge and the cartridge is replaceably mounted on or dismounted from an apparatus body of an image forming apparatus.

Thanks to this cartridge system, the operability is further enhanced so that the maintenance of the above-mentioned process means such as the charging means, the developing means, the cleaning means and the like can be easily performed by a user himself. Accordingly, this cartridge system has been popularly used in the apparatus body of the image forming apparatus.

Further, there has been also realized a cartridge constitution in which the process means is classified into process means having a long life time and a process means having a short life time and these respective process means are formed into cartridges and can be used in accordance with the life time of the main process means. For example, a developing cartridge in which a toner accommodating portion and the developing means are integrally formed, a drum cartridge in which the photosensitive drum, the charging means and the cleaning means are integrally formed and the like are adopted.

In such a cartridge-type image forming apparatus, as a developing method which has been conventionally used, a so-called magnetic brush developing method has been known. In this magnetic brushing method, using a two component developer consisting of non-magnetic toner and magnetic carrier, a magnetic brush is formed on a surface of a developer bearing member (also referred to as a developing sleeve hereinafter) which arranges a magnet in the inside thereof. Then, this magnetic brush is brought into slidable and frictional contact with or is arranged in the vicinity of the photosensitive drum which is arranged to face the developing sleeve in an opposed manner while maintaining a minute developing gap therebetween. Subsequently, an electric field is continuously applied between the developing sleeve and the photosensitive drum. Accordingly, the developing is performed by repeatedly performing the transfer of the toner particle from the developing sleeve side to the photosensitive drum side and the inverse transfer of such toner particles.

Here, in this magnetic brush developing method, the non-magnetic toner and the magnetic carrier are agitated and are transported by a screw and are eventually supplied to the developing sleeve. Such a constitution has been conventionally popularly adopted.

Recently, along with the demand for high speed operation of a printer, not to mention the peripheral speed of the photosensitive drum, a peripheral speed of the developing sleeve in the inside of the developing device is increased thus giving rise to the elevation of an internal pressure and the occurrence of an air flow in the inside of the developing device.

There exists a possibility that the developer scatters through a minute gap due to these phenomena. The scattering of the developer smears in the inside of the process cartridge, a scanner and the electrophotographic image forming apparatus including the developing device.

### SUMMARY OF THE INVENTION

Accordingly, it is an object of the present invention to provide a developing device, a process cartridge and an electrophotographic image forming apparatus which can prevent leaking of a developer.

It is another object of the present invention to provide a developing device, a process cartridge and an electrophotographic image forming apparatus which can prevent scattering of a developer into an exposure optical path which may be caused by leaking of the developer.

It is still another object of the present invention to provide a developing device, a process cartridge and an electrophotographic image forming apparatus which can prevent the elevation of an internal pressure in the inside of a developer containing portion.

It is a further object of the present invention to provide a developing device for developing a latent image formed on an electrophotographic photosensitive member used in an electrophotographic image forming apparatus, wherein the developing device includes a developing member for developing the latent image formed on the electrophotographic photosensitive member, an exposure optical path for guiding an exposure light emitted from exposure means mounted in a body of the electrophotographic image forming apparatus to the electrophotographic photosensitive member, a developer containing portion for containing a developer which is used by the developing member for developing the latent image, a vent port for allowing air in the inside of the developer containing portion to pass therethrough, a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member, a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member, and a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member.

It is a still further object of the present invention to provide a process cartridge which is detachably attachable mounted on a body of an electrophotographic image forming apparatus, wherein the process cartridge includes an electrophotographic photosensitive member, a developing member for developing the latent image formed on the electrophotographic photosensitive member, an exposure optical path for guiding an exposure light emitted from exposure means mounted in a body of the electrophotographic image forming apparatus to the electrophotographic photosensitive member, a developer containing portion for containing a developer which is used by the developing member for developing the latent image, a vent port for allowing air in the inside of the developer containing portion to pass therethrough, a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member, a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member, and a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member.

It is a still further object of the present invention to provide an electrophotographic image forming apparatus for forming an image on a recording medium, wherein the electrophotographic image forming apparatus includes (a) exposure means, (b) a developing device for developing a latent image formed on an electrophotographic photosensitive member used in the electrophotographic image forming apparatus, the developing device including a developing member for developing the latent image formed on the electrophotographic photosensitive member, an exposure optical path for guiding an exposure light emitted from exposure means mounted in a body of the electrophotographic image forming apparatus to the electrophotographic photosensitive member, a developer containing portion for containing a developer which is used by the developing member for developing the latent image, a vent port for allowing air in the inside of the developer containing portion to pass therethrough, a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member, a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member, and a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member, and (c) conveying means for conveying the recording medium.

It is another object of the present invention to provide an electrophotographic image forming apparatus for forming an image on a recording medium on which a process cartridge can be detachably attachable mounted, wherein the electrophotographic image forming apparatus includes (a) exposure means, (b) mounting means for detachably mounting the process cartridge which including an electrophotographic photosensitive member, a developing member for developing the latent image formed on the electrophotographic photosensitive member, an exposure optical path for guiding an exposure light emitted from exposure means mounted in a body of the electrophotographic image forming apparatus to the electrophotographic photosensitive member, a developer containing portion for containing a developer which is used by the developing member for developing the latent image, a vent port for allowing air in the inside of the developer containing portion to pass therethrough, a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member, a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member, and a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member, and (c) conveying means for conveying the recording medium.

These and other objects, features and advantages of the present invention will become more apparent upon consideration of the following description of the preferred embodiments of the present invention taken in conjunction with the accompanying drawings.

### BRIEF DESCRIPTION OF DRAWINGS

FIG. 1 is a cross-sectional view showing an image forming apparatus body according to one embodiment of the present invention.

FIG. 2 is a cross-sectional view showing a process cartridge and a toner replenishing container according to this embodiment.

FIG. 3 is a schematic perspective view showing the image forming apparatus body according to this embodiment.

FIG. 4 is a longitudinal cross-sectional view showing the process cartridge according to this embodiment

FIG. 5 is a cross-sectional view substantially showing an insulation sheet member according to this embodiment.

FIG. 6 is a longitudinal schematic view showing a developer according to this embodiment.

FIG. 7 is a cross-sectional view substantially showing both end portions of a developing sleeve according to this embodiment.

FIG. 8 is an upper plan view showing the process cartridge according to this embodiment.

FIG. 9 is a schematic view showing a filter member according to this embodiment.

### DETAILED DESCRIPTION OF THE PREFERRED EMBODIMENT

Preferred embodiments of the present invention are explained in an illustrating manner in conjunction with attached drawings hereinafter. However, sizes, materials, shapes and relative arrangements of constitutional parts described in these embodiments should not be construed to limit the scope of the present invention to these values unless otherwise specified in the specification.

In the following description, the longitudinal direction is defined as a direction which is orthogonal to the conveying direction of a recording medium 52 and is the direction equal to an axial direction of an electrophotographic photosensitive member which constitutes an image bearing member (hereinafter referred to as a photosensitive drum 2). Further, the term “left and right” is defined as left and right as viewed from the conveying direction of the recording medium 52. Further, the term “upper and lower” means upper and lower in a state that a cartridge is mounted in the electrophotographic image forming apparatus.

[Explanation of the Entire Electrophotographic Image Forming Apparatus]

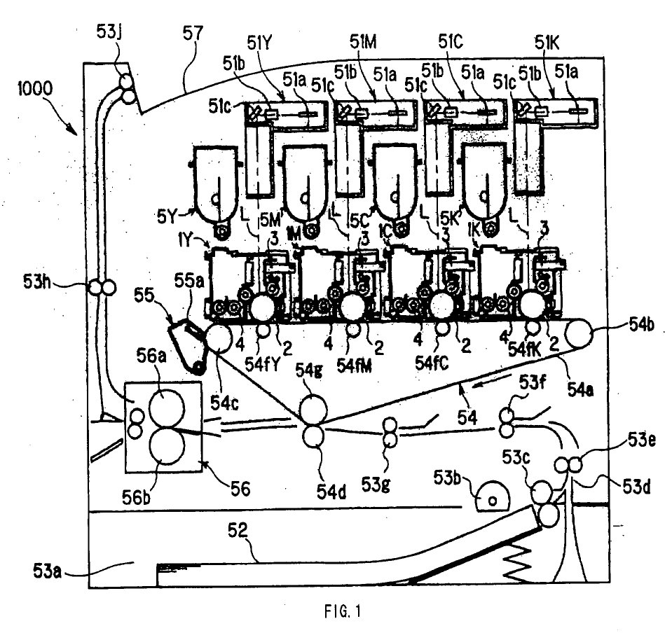

First, the entire configuration of a color electrophotographic image forming apparatus will be schematically explained in conjunction with FIG. 1.

FIG. 1 is an explanatory view showing the entire configuration of a color laser beam printer which constitutes one form of a color toner image forming apparatus.

An image forming portion of an apparatus body 1000 of the color laser beam printer includes four process cartridges 1Y, 1M, IC, 1K (yellow, magenta, cyan, black) each having a photosensitive drum 2 which constitutes an image bearing menber and exposure means 51Y, 51M, 51C, 51K (laser beam optical scanning systems) which are arranged in parallel above the process cartridges 1Y, 1M, 1C, 1K corresponding to respective colors.

Below the above-mentioned image forming portion, feeding means for feeding the recording medium 52, an intermediate transfer belt 54a for transferring a toner image formed on the photosensitive drum 2, and a secondary transfer roller 54d for transferring a toner image on the intermediate transfer belt 54a onto the recording medium 52 are arranged.

Further, below the above-mentioned image forming portion, a fixing device 56 which constitutes fixing means for fixing the recording medium 52 onto which a toner image has been transferred and a tray 57 which stacks the recording medium 52 which is discharged outside the image forming apparatus are disposed.

Here, the recording medium 52 is, for example, a paper, an OHP sheet, a cloth or the like.

The image forming apparatus of this embodiment is of a cleanerless system. Thus, toner remaining on the photosensitive drum 2 after transfer is carried in the developing device. 4 which constitutes developing means and a cleaner which is used for exclusively collecting and reserving toner remaining after transfer is not provided in the inside of the process cartridges.

Subsequently, configurations of the respective portions of the above-mentioned image forming apparatus are sequentially explained in detail.

[Feeding Means]

The feeding means feeds the recording medium 52 to the image forming portion. The feeding means mainly includes a feed cassette 53a containing stacked sheets of recording medium 52, a feed roller 53b, an anti-double-feed retard roller 53c, a feed guide 53d and a registration roller 53g.

The feed roller 53b is rotationally driven in accordance with an image forming operation and separates and feeds the recording medium 52 in the feed cassette 53a for every one sheet.

The recording medium 52 is guided with the feed guide 53d and is conveyed to the registration roller 53g through the conveying rollers 53e, 53f.

Immediately after the recording medium 52 is conveyed to the registration roller 53g, the registration roller 53g is in a non-rotation mode. A skewing of the recording medium 52 is corrected by hitting a leading end of the recording medium 52 to a nip portion of the registration roller 53g.

During the image forming operation, the registration roller 53g performs a non-rotary operation for allowing the recording medium 52 to rest/wait and a rotary operation for conveying the recording medium 52 to the intermediate transfer belt 54a at a given sequence. Thereafter, the registration roller 53g performs the registering or the alignment between the toner image and the recording medium 52 at the time of a transfer step which is a next step.

[Process Cartridge]

In each of the process cartridges 1Y, 1M, 1C, 1K (hereinafter also referred to as “process cartridges 1), a charging device 3 which constitutes the charging means and a developing device 4 are arranged around the photosensitive drum 2 and they are integrally formed. The process cartridge 1 can be easily detached by a user from the apparatus body and can be replaced when the life of the photosensitive drum 2 expires.

In this embodiment, for example, the number of rotation of the photosensitive drum 2 is counted, and when the number of rotation exceeds a given count number, an alarm indicates that the life of the process cartridge 1 has expired.

The photosensitive drum 2 in this embodiment is of a negatively charged organic photosensitive member. The photosensitive drum 2 has a photosensitive layer that is usually used on an aluminum drum substrate having a diameter of about 30 mm and provides a charge injection layer on an outermost surface layer thereof. Further, the photosensitive drum 2 is rotatably driven at a given process speed, that is, about 117 mm/sec in this embodiment.

As the charge injection layer of the photosensitive drum 2, a coated layer which is made of a material in which, for example, SnO₂ ultra fine particles as conductive fine particles are dispersed into an insulating resin binder is used.

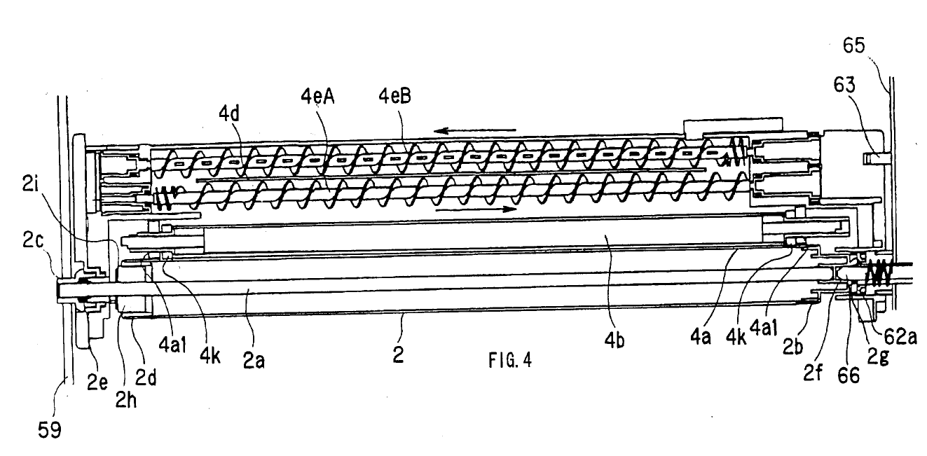

As shown in FIG. 4, a drum flange 2b is fixed to a rear-side end portion of the photosensitive drum 2 and a non-driving flange 2d is fixed to a front-side end portion. A drum shaft 2a penetrates the centers of the drum flange 2b and the non-driving flange 2d such that the drum shaft 2a, the drum flange 2b and the non-driving flange 2d are integrally rotated. That is, the photosensitive drum 2 is rotated about the axis of the drum shaft 2a.

The front-side end portion of the drum shaft 2a is rotatably supported on a bearing 2e The bearing 2e is fixed to a bearing case 2c. Further, the bearing case 2c is fixed to a frame of the process cartridge 1.

[Charging Means]

The charging device 3 which constitutes charging means uses a contact charging method. In this embodiment, a charging roller 3a is used as a charging member.

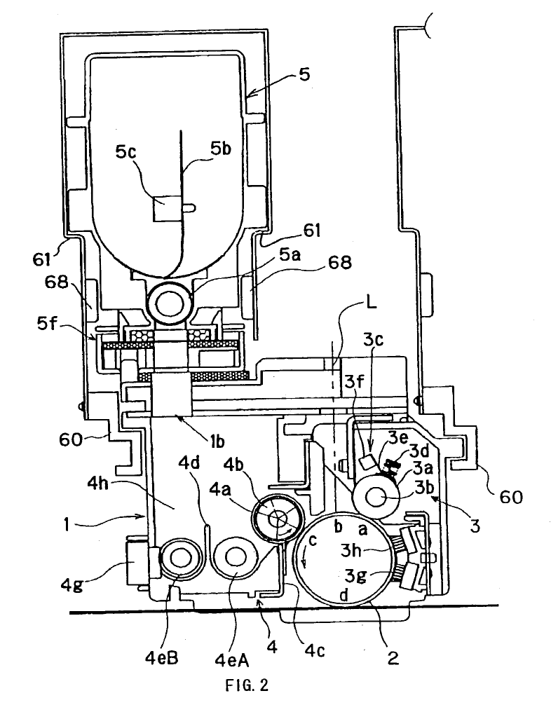

As shown in FIG. 2, the charging roller 3a has both end portions of a core 3b thereof rotatably supported on bearing members not shown in the drawings Further, the charging roller 3a is biased toward the photosensitive drum 2 due to a compression spring 3d such that the charging roller 3a is brought into pressure contact with a surface of the photosensitive drum 2 with a given pressing force and is rotated in accordance with the rotation of the photosensitive drum 2.

A charging roller cleaning member 3c includes, in this embodiment, a cleaning film 3e having flexibility.

The cleaning film 3e is arranged parallel to the longitudinal direction of the charging roller 3a. Further, the cleaning film 3e has one end thereof fixed to a support member 3f which performs a reciprocating movement of a fixed amount in the longitudinal direction of the charging roller 3a, while the cleaning film 3e defines a contact nip with the charging roller 3a on a face thereof in the vicinity of a free end side thereof.

Due to the reciprocating movement of the support member 3f by a fixed amount in the longitudinal direction due to driving means (not shown in the drawings), a surface of the charging roller 3a is scraped by a cleaning film 3e. Accordingly, a fouling (fine powdery toner, external additives and the like) on the surface of the charging roller 3a is removed.

Here, the image forming apparatus of this embodiment adopts a cleanerless system. This cleanerless system is explained hereinafter.

[Cleanerless System]

The summary of the cleanerless system in the image forming apparatus of this embodiment is explained first. That is, in the cleanerless system, the toner remaining after transfer on the photosensitive drum 2 is, along with the subsequent rotation of the photosensitive drum 2, allowed to pass through a charging portion “a” and an exposure portion “b” and then is carried to a developing portion “c” and is cleaned (collected) simultaneously with developing by the developing device 4.

Since the toner remaining after transfer on the photosensitive drum 2 passes through the exposure portion “b”, the exposure step is performed over the toner remaining after transfer. However, since a quantity of toner remaining after transfer is small, no significant influence takes place.

However, toner having the normal polarity, toner having the inverse polarity (inverted toner) and toner with an insufficient charging quantity are mixed in the toner remaining after transfer. When the inverted toner and the toner with an insufficient charging quantity pass through the charging portion “a”, they are adhered to the charging roller 3a and hence, the charging roller 3a is contaminated with the toner which exceeds an allowable quantity thus giving rise to a defective charging.

Further, to effectively perform the cleaning of the toner remaining after transfer on the surface of the photosensitive drum 2 simultaneously with developing by the developing device 4, it is necessary that the charged polarity of the toner remaining after transfer on the photosensitive drum 2 carried to the developing portion “c” assumes the normal polarity and the charging quantity is a charging quantity which the developing device 4 can develop a charged latent image on the photosensitive drum 2. That is, with respect to the inverted toner and the toner having an improper charging quantity, it is difficult to remove and collect them from the photosensitive drum 2 to the developing device 4 thus giving rise to the defective image.

Accordingly, in this embodiment, at a position downstream of the transfer portion “d” with respect to the photosensitive drum 2, means “3g” for making post-transfer remaining toner (residual developer image) uniform which can disperse the transfer residual toner uniformly on the surface of the photosensitive drum 2 is provided.

Further, at a position downstream of this means 3g for making post-transfer remaining toner uniform in the rotational direction of the photosensitive drum 2 and upstream of the charging portion “a” in the rotational direction of the photosensitive drum 2, toner (developer) charging control means 3h which arranges the charging polarity of the toner remaining after transfer to the negative polarity which is the normal polarity is provided.

By providing the means 3g for making post-transfer remaining toner uniform, even when the toner remaining after transfer in a pattern on the photosensitive drum 2 which is carried from the transfer portion “d” to the toner charging control means 3h is large in quantity, the toner is dispersed and distributed over the surface of the photosensitive drum 2 so that the pattern is dissipated. Accordingly, there is no possibility that the toner is concentrated at a portion of the toner charging control means 3h so that the overall normal polarity charging treatment of the toner remaining after transfer can be sufficiently performed by the toner charging control means 3h. Accordingly, it is possible to effectively prevent the toner remaining after transfer from adhering to the charging roller 3a. Further, it is also possible to prevent the occurrence of a ghost image of the pattern of toner remaining after transfer.

According to this embodiment, the means 3g for making post-transfer remaining toner uniform and the toner charging control means 3h are formed of a brush-like member having a proper conductivity and bring brush portions thereof into contact with the surface of the photosensitive drum 2.

Further, the means 3g for making post-transfer remaining toner uniform and the toner charging control means 3h are arranged to move (reciprocating movement) in the longitudinal direction of the photosensitive drum 2 by a driving source not shown in the drawing. Due to such a constitution, it is possible to obviate a state in which the means 3g for making post-transfer remaining toner uniform and the toner charging control means 3h are fixedly held continuously at the same positions along the photosensitive drum 2. Accordingly, even when excessively charged portions or the charging shortage portions are present due to irregularities in resistance of the toner charging control means 3h, for example, they do not always take place at the same portions of the surface of the photosensitive drum 2. That is, the occurrence of melting of toner on the photosensitive drum 2 attributed to the excessive charging of an extremely minute toner remaining after transfer or the occurrence of adhesion of the toner remaining after transfer to the charging roller 3a attributed to the shortage of charging can be prevented or attenuated.

[Exposure Means]

In this embodiment, exposure to the above-mentioned photosensitive drum 2 is carried out by the exposure means 51Y, 51M, 51C, 51K which constitute the laser exposure means. That is, when an image signal is transmitted from the apparatus body 1000, a laser beam L modulated in response to this signal is applied to the uniformly charged surface of the photosensitive drum 2 by scanning. An electrostatic latent image corresponding to the image information is selectively formed on the surface of the photosensitive drum 2.

Each of the exposure means 51Y, 51M, 51C, 51K is composed of a solid-state laser element (not shown in the drawing), a polygon mirror 51a, an imaging lens 51b, a reflective mirror 51c and the like.

The solid-state laser element is ON/OFF light emission controlled at a desired timing with a light emission signal generator (not shown in the drawing) based on the inputted image signal in the exposure means 51Y, 51M, 51C and 51K. The laser beam L emitted from the solid-state laser element is converted into a flux of substantially parallel beams with a collimator lens system (not shown in the drawing) and is scanned with the polygon mirror 51a which is rotated at a high speed. And the beam is imaged on the photosensitive drum 2 in a spot shape through the imaging lens 51b and the reflective mirror 51c.

Thus, the laser beam scanning exposure in the main scanning direction and the exposure in the sub-scanning direction due to the rotation of the photosensitive drum 2 are applied onto the surface of the photosensitive drum 2 to thereby obtain an exposure distribution in accordance with the image signal.

That is, by the irradiation and the non-irradiation of laser beam L, a surface potential reduced highlight potential and a surface potential non-reduced shadow potential are respectively formed. And by a contrast between the highlight potential and the shadow potential, an electrostatic latent image corresponding to the image information is formed.

[Developing Means]

The developing device 4 which constitutes the developing means is a two-component contact developing device (two-component magnetic brush developing device) and holds, as shown in FIG. 2, a developer which is composed of carrier and toner on a developing sleeve 4a. The developing sleeve 4a constitutes a developer bearing member and a magnet roller 4b is disposed in the inside of the developing sleeve 4a.

The developing sleeve 4a is provided with a regulating blade 4c which constitutes a layer thickness restricting member, wherein a desired gap is formed between the developing sleeve 4a and the regulating blade 4c. By the rotation of the developing sleeve 4a in the direction indicated by a narrow, the developer which is carried on the developer sleeve 4a is regulated to a thin layer by the regulating blade 4c.

The developing sleeve 4a allows, as shown in FIG. 4, developing spacer 4k to be rotatably fitted on narrow-diametered journal portions 4a1 provided at both sides thereof. Accordingly, the developing sleeve 4a is arranged to define a given gap between the developing sleeve 4a and the photosensitive drum 2, wherein at the time of developing, the developing is performed in a state that the developer formed on the developing sleeve 4a is in contact with the photosensitive drum 2.

The developing sleeve 4a is rotatably driven at the developing portion “c” at a given peripheral speed in the direction indicated by an arrow which is a direction opposite to the rotational direction of the photosensitive drum 2.

The toner used in this embodiment is a negatively charged toner with an average particle diameter of 6 μm. Further, as a magnetic carrier, a magnetic carrier having a saturated magnetization of 205 emu/cm³ and an average particle diameter of 35 μm is used. Further, as a developer, a mixture of toner and carrier mixed at the weight ratio of 6:94 is used.

A developer containing portion 4h in which a developer is circulated is divided into two portions with a partition wall 4d extending in the longitudinal direction except for both end portions of the developer containing portion 4h. Here, agitating screws 4eA, 4eB are placed so as to sandwich the partition wall 4d.

The toner replenished from a toner replenishing containers 5Y, 5M, 5C, 5K (hereinafter also referred to as a toner replenishing container 5), as shown in FIG. 4, falls down on the rear side of the agitating screw 4eB and is agitated while being fed to the front side in the longitudinal direction and is passed through a portion without the partition wall 4d on the front side end. Then, the toner is further fed to the rear side in the longitudinal direction with the agitating screw 4eA and is passed through a portion without the partition wall 4d on the rear side and is agitated while being fed using the agitating screw 4eB. Thus, the circulation is repeated.

Developing steps of visualizing an electrostatic latent image formed on the photosensitive drum 2 by the two-component magnetic brush process using the developing device 4 and the circulation system of developer are explained hereinafter. By the rotation of the developing sleeve 4a, a developer in the developer containing portion 4h is drawn to the surface of the developing sleeve 4a with a draw-up pole of the magnet roller 4b and is fed.

In the process of feeding the developer, the layer thickness of developer is regulated with the regulating blade 4c placed vertically to the developing sleeve 4a, and a thin layered developer is formed on the developing sleeve 4a.

When the thin layered developer on the developing sleeve 4a is fed to a developing pole corresponding to the developing portion “c”, a magnetic brush is formed by a magnetic force. An electrostatic latent image on the surface of the photosensitive drum 2 is developed by toner in the developer which stands like the ears of rise as a toner image. The electrostatic latent image is developed while reversed in this embodiment.

A thin layered developer on the developing sleeve 4a which has passed through a developing portion “c” is subsequently fed into the developer containing portion 4h by the rotation of the developing sleeve 4a and is left from the surface of the developing sleeve 4a by a repulsion magnetic field in a carrying pole to return to a developer reservoir in the developer containing portion 4h.

A direct current (DC) voltage and an alternating current (AC) voltage are applied from a power supply (not shown in the drawing) to the developing sleeve 4a. In this embodiment, a DC voltage of −500 V and an AC voltage of peak-to-peak voltage of 1500 V at the frequency of 2000 Hz are applied to selectively develop only the exposed portions having highlight potential of photosensitive drum 2 exposed by the exposure portion “b”.

When the AC voltage is applied in the two-component developing process in general, the developing efficiency is increased to obtain an image having high quality. However, there arises a fear that fogging may easily occur. Therefore, prevention of the fogging is usually realized by providing the potential difference between the DC voltage applied to the developing sleeve 4a and the surface potential of the photosensitive drum 2. To be more specific, the bias voltage of a potential difference between the highlight potential of the exposed portion and the shadow potential of the non-exposed portion of the photosensitive drum 2 is applied.

When toner is consumed by developing, the toner density in a developer is decreased. In this embodiment, a sensor 4g which detects the toner density is placed at a position in the vicinity of the outer periphery surface of the agitating screw 4eB. When the sensor 4g detects that the toner density in the developer is further decreased than a desired density level, an instruction to replenish toner from the toner replenishing container 5 to the developing device 4 is issued. By this toner replenishing operation, the toner density of the developer in the inside of the developer containing portion 4h can be always maintained and controlled at a given level.

[Toner Replenishing Container]

The toner replenishing containers 5Y, 5M, 5C, 5K are placed above the process cartridges 1Y, 1M, 1C, 1K in parallel to each other and are mounted from the front side of the apparatus body 1000.

As shown in FIG. 2, in the toner replenishing container 5, an agitating plate 5b which is fixed to an agitating shaft 5c and a screw 5a are disposed. A discharge port portion 5f which is served for discharging toner is formed on the bottom surface of the container.

The screw 5a and the agitating shaft 5c have respective both ends thereof rotatably supported by bearings. A drive coupling (concave) is placed on one tip end thereof. The drive coupling (concave) receives driving transmission from a drive coupling (convex) of the apparatus body 1000 and is rotatably driven.

The outer configuration of the screw 5a has a spiral 11b shape and the twist direction of the spiral shape is reversed while setting the discharge port portion 5f as the center.

By the rotation of the drive coupling (convex), the screw 5a is rotated in a desired rotational direction. Due to such an operation, toner is fed toward the discharge port portion 5f and freely falls down from an opening of the discharge port portion 5f, to thereby replenish toner in the process cartridges 1.

The distal end portion of the agitating plate 5b in the radial direction of rotation is slanted. When the distal end portion is brought into sliding contact with the inner wall surface of the toner replenishing container 5, the distal end portion contacts the surface at an angle. To be more specific, the distal end side of the agitating plate 5b is twisted to form a spiral-shape. Thus, by the twist inclination on the distal end side of the agitating plate 5b, the feeding force in the axial direction of the agitating shaft 5c is generated so that toner is fed in the longitudinal direction.

The toner replenishing container 5 of this embodiment is not limited to the two component developing method and toner can be replenished to process cartridges or developing cartridges which adopt one component developing method. Further, it is needless to say that powdery material which can be contained in the toner replenishing container is not limited to toner and a so-called developer which is a mixture of toner and magnetic carrier can be filled in the container.

[Transfer Means]

An intermediate transfer unit 54 which constitutes transfer means secondarily collectively transfers a plurality of toner images which have been sequentially primarily transferred from the photosensitive drums 2 and superimposed on one another to the recording medium 52.

The intermediate transfer unit 54 is provided with an intermediate transfer belt 54a running in a direction indicated by an arrow and runs in the arrow direction at a peripheral speed substantially the same as the outer peripheral speed of the photosensitive drum 2. The intermediate transfer belt 54a is an endless belt with a circumferential length of about 940 mm and is extended around three rollers consisting of a drive roller 54b, a secondary transfer opposed roller 54g and a driven roller 54c Further, in the inside of the intermediate transfer belt 54a, transfer charging rollers 54fY, 54fM, 54fC, 54fK are rotatably placed at positions respectively opposed to the photosensitive drums 2 and are pushed in the respective central directions of the photosensitive drums 2.

The transfer charging rollers 54fY, 54fM, 54fC, 54fK are energized from a high voltage power supply (not shown in the drawing) to perform charging with polarity opposite to that of toner from the back side of the intermediate transfer belt 54a and primarily transfer the toner images on the photosensitive drums 2 to the upper surface of the intermediate transfer belt 54a sequentially.

A secondary transfer roller 54d which constitutes a transfer member is in pressure contact with the intermediate transfer belt 54a at a position opposed to the secondary transfer opposed roller 54g in the secondary transfer portion. The secondary transfer roller 54d can perform an up-and-down-motion in the drawing and is also rotated. At this time, bias is simultaneously applied to the intermediate transfer belt 54a so that the toner image on the intermediate transfer belt 54a is transferred to the recording medium 52.

In this step, the intermediate transfer belt 54a and the secondary transfer roller 54d are respectively driven. When the recording medium 52 enters the secondary transfer portion, a given bias is applied to the secondary transfer roller 54d and the toner image on the intermediate transfer belt 54a is secondarily transferred to the recording medium 52.

Simultaneously with performing of the transfer step in which the recording medium 52 sandwiched between the intermediate transfer belt 54a and the secondary transfer roller 54d is transferred, the recording medium 52 is fed at a given speed in the leftward direction in the drawing to a fixing device 56 which constitutes fixing means served for the next step.

At a given position on the intermediate transfer belt 54a of the most downstream side in the transfer process, a cleaning unit 55 which can be brought into contact with and can be separated from the surface of the intermediate transfer belt 54a is provided. The cleaning unit 55 removes toner remaining on the surface of the intermediate transfer belt 54a after the secondary transfer.

A cleaning blade 55a for removing the toner remaining on the surface of the intermediate transfer belt 54a after the secondary transfer is placed in the inside of the cleaning unit 55.

The cleaning unit 55 is swingably mounted at the rotation center (not shown in the drawing). The cleaning blade 55a is brought into pressure contact with the intermediate transfer belt 54a in an inroading direction.

The transfer residual toner drawn into the cleaning unit 55 is fed to a waste toner tank (not shown in the drawing) with a feeding screw and is stored therein.

Here, as the intermediate transfer belt 54a, an intermediate transfer belt made of polyimide resin can be used in this embodiment. The material of the intermediate transfer belt 54a is not limited to the polyimide resin, and plastics such as polycarbonate resin, polyethylene terephthalate resin, polyvinylidene fluoride resin, polyethylene naphthalate resin, polyether ether ketone resin, polyethersulfone resin, and polyurethane resin, and fluorine series rubber and silicone series rubber can be preferably used.

[Fixing Means]

A toner image formed on the photosensitive drum 2 with the developing device 4 is transferred to the recording medium 52 through the intermediate transfer belt 54a. Then, the fixing device 56 which constitutes fixing means fixes the toner image transferred to the recording medium 52 to the recording medium 52 with heat.

As shown in FIG. 1, the fixing device 56 is provided with a fixing roller 56a for imparting heat to the recording medium 52 and a pressure roller 56b for bringing the recording medium 52 into pressure contact with the fixing roller 56a. Each of the fixing roller 56a and the pressure roller 56b is formed of a hollow roller. Each of the fixing roller 56a and the pressure roller 56b has a heater (not shown in the drawing) therein.

The fixing roller 56a and the pressure roller 56b are rotatably driven to feed the recording medium 52 simultaneously.

That is, the recording medium 52 holding the toner image thereon is fed using the fixing roller 56a and the pressure roller 56b and, at the same time, the toner image is fixed to the recording medium 52 by being applied with heat and pressure. The recording medium 52 fixed the toner image is discharged through discharge rollers 53h, 53j and is stacked on a tray 57 on the apparatus body 1000.

[Mounting of Process Cartridge and Toner Replenishing Container]

Next, mounting procedures of the process cartridges 1 and the toner replenishing containers 5 will be described with reference to FIG. 2 to FIG. 4.

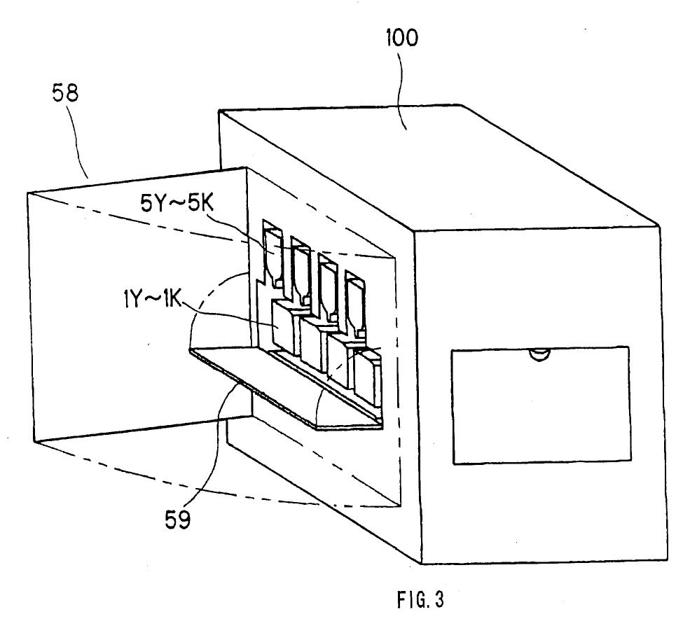

As shown in FIG. 3, a front door 58 which can be opened and closed is provided in the front of the apparatus body 1000. When the front door 58 is opened in the direction toward the front side, opening portions which allow the insertion of the process cartridges 1 and the toner replenishing containers 5 are exposed.

A pivotably supported centering plate 59 is placed on the opening portions for inserting the process cartridges 1. When the process cartridges 1 are inserted or removed, the centering plate 59 is first opened before the insertion or the removal.

In the apparatus body 1000, as shown in FIG. 2, guide rails 60 which guide the mounting of the process cartridges 1 and guide rails 61 which guide the mounting of the toner replenishing containers 5 are fixed.

A direction of mounting the process cartridges 1 and the toner replenishing containers 5 is parallel to the axial direction of the photosensitive drum 2. The guide rails 60, 61 are placed in the same direction as the mounting direction.

The process cartridges 1 and the toner replenishing containers 5 are slid and inserted from the front side to the rear side in the apparatus body 1000 along the guide rails 60, 61.

When the process cartridges 1 are completely inserted into the rearmost side, as shown in FIG. 4, centering shafts 66 of the apparatus body 1000 are inserted into center holes 2f of the drum flanges 2b so that the center positions of rotation on the rear sides of the photosensitive drums 2 are determined with respect to the apparatus body 1000.

At the same time, drive transmission portions 2g which are formed on the drum flanges 2b are connected to driving couplings (convex) 62a so that photosensitive drums 2 can be rotatably driven. In this embodiment, the drive transmission portion 2g has a twisted triangular shape, wherein when a driving force from the apparatus body 1000 is imparted to the drive transmission portion 2g, a force which pulls the photosensitive drum 2 into the rear side is generated.

A support pin 63 for positioning each process cartridge 1 is arranged on a back side plate 65. The support pin 63 is inserted into a frame of the process cartridge 1 so that the position of the frame of the process cartridge 1 is fixed.

The pivotable centering plate 59 is placed on the front side of the apparatus body 1000. A bearing case 2c of each of the process cartridges 1 is supported and fixed to this centering plate 59. By such a series of inserting operations, the process cartridges 1 including the photosensitive drums 2 can be positioned with respect to the apparatus body 1000.

On the other hand, when the toner replenishing containers 5 are completely inserted to the rearmost side, the toner replenishing containers 5 are fixed to support pins protruding from the back side plate 65. At the same time, a drive couplings (concave) and the drive couplings (convex) are connected to each other and the screws 5a and the agitating shafts 5c can be rotatably driven.

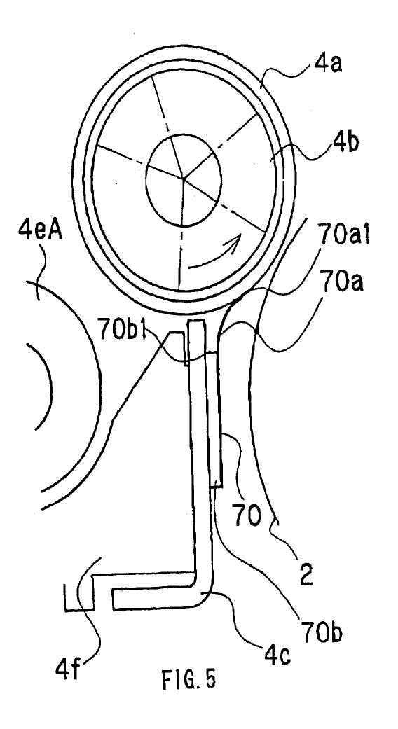

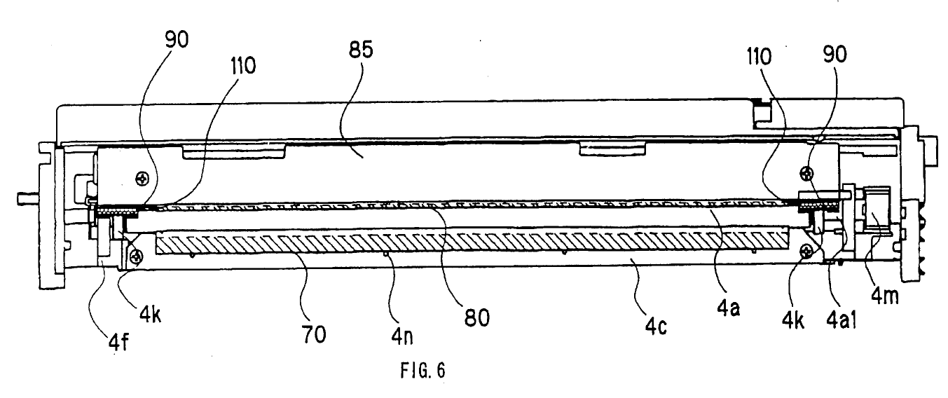

Then, the constitutional features of the present invention are explained in conjunction with FIG. 5 to FIG. 9.

First of all, an insulating sheet member 70 which constitutes a second sheet member is explained. The insulating sheet member 70 is constituted of an insulating sheet 70a and a laminating member 70b.

The insulating sheet 70a is made of polyurethane in a sheet shape having flexibility of JISA hardness of not less than 50° and not more than 110° defined in K-6253 of JIS standard and a thickness of not less than 30 μm and not more than 120 μm. Further, the insulating sheet 70a is formed in a shape projected from the laminating member 70b and is fixed to the laminating member 70b using a pressure sensitive adhesive double coated tape.

The laminating member 70b is a sheet-like resin member and is preferably made of resin having excellent strength such as polyethylene terephthalate (PET), polyacetal (POM), for example.

Further, the insulating sheet member 70 is fixed to the surface of the regulating blade 4c such that the distal end of the insulating sheet 70a is projected from the regulating blade 4c using a pressure sensitive adhesive double coated tape.

Here, as viewed from the distal end of the regulating blade 4c, an upper end 70b1 of the laminating member 70b assumes a lower position and a distal end 70a1 of the insulating sheet 70a assumes an upper position.

Further, with the provision of the laminating member 70b, at the time of assembling, it is possible to suppress the irregularities of a projection amount of the distal end of the insulating sheet 70a from the regulating blade 4c and, at the same time, wrinkling and waving of the insulating sheet 70a can be prevented. It is needless to say that the laminating member 70b may be omitted.

The distal end 70a1 of the insulating sheet 70a has a free length of 3 to 5 mm such that the distal end 70a1 is brought into contact with the developer layer after passing the regulating blade 4c at the upstream of the developing region in the rotational direction of the developing sleeve 4a. As shown in FIG. 5, the free length means a length from the distal end 70a1 of the insulating sheet 70a to the upper end 70b1 of the laminating member 70b. There is no limit with respect to the free length provided that the length is set such that the insulating sheet 70a is brought into contact with the developer layer but the insulating sheet 70a does not invade the developing region.

Along with the lapse of use time of the developing device 4, the deterioration of the developer (non-magnetic toner and magnetic carrier) gradually progresses and hence, toner with an insufficient charging quantity (low triboelectrified toner) is generated and the low triboelectrified toner is gradually accumulated in the inside of the developing device 4. The low triboelectrified toner exhibits the low electrostatic attraction force to the magnetic carrier and hence, the toner is liable to be easily liberated from the magnetic carrier. Accordingly, when the low triboelectrified toner reaches the gap between the developing sleeve 4a and the regulating blade 4c, the toner stays and is coagulated in the gap whereby the toner is gradually accumulated as a block.

However, since the insulating sheet member 70 is directly brought into contact with the developing layer, it is possible to prevent falling of toner block accumulated in the gap between the developing sleeve 4a and the regulating blade 4c. At the same time, since the toner block is subjected to the scraping of the magnetic brush which moves along with the rotation of the developing sleeve 4a, the coagulation of the toner block is loosened and the toner slips the gap little by little whereby it is possible to prevent the toner block from being excessively accumulated in the gap between the developing sleeve 4a and the regulating blade 4c.

Further, the insulating sheet member 70 suppresses an air flow from the developer containing portion 4h generated by the rotation of the agitating screws 4eA, 4eB and the developing sleeve 4a over the whole longitudinal area of the opening portion defined between the developing sleeve 4a and the regulating blade 4c.

An insulating sheet member 80 which constitutes a first sheet member is made of polyurethane in a sheet shape having JISA hardness of not less than 50° and not more than 110° defined in K-6253 of JIS standard and a thickness of not less than 30 μm and not more than 120 μm.

The insulating sheet member 80 is fixed to the cover member 85 located above the developing sleeve 4a covering the whole longitudinal area of the developing sleeve 4a using a pressure sensitive adhesive double coated tape.

Further, the insulating sheet member 80 is formed such that a distal end thereof is projected from a cover member 85.

The insulating sheet member 80 is brought into contact with the photosensitive drum 2, interrupts the air flow generated by the rotation of the photosensitive drum 2, and suppresses scattering of toner above the developing sleeve 4a.

Subsequently, sealing members 90 are explained. The sealing members 90 are made of a elastic body, a surface of which is covered with woven material.

The sealing members 90 are fixed to the cover member 85 using a pressure sensitive adhesive double coated tape and are positioned upstream of positions (two longitudinal portions) where the developing spacers 4k are brought into contact with the photosensitive drum 2. The sealing members 90 are provided for preventing the toner and the carrier adhered to the surface of the photosensitive drum 2 from being adhered to the developing spacers 4k.

The sealing member 90 is brought into contact with the photosensitive drum 2 in a range covering 20 mm at respective sides of the developing spacer 4k. Further, the sealing member 90 is positioned outside the insulating sheet member 70 and the insulating sheet member 80.

On the other hand, sealing members 100 are made of a elastic body having a felt-like surface. The sealing member 100 is fixed to arcuate portions 4q of the developing device 4 defining fixed gaps with the circumference of the developing sleeve 4a using a pressure sensitive adhesive double coated tape. The arcuate portions 4q of the developing device 4 are positioned at both longitudinal ends of the opening portion of the developer containing portion 4h. The positions of the arcuate portions 4q substantially correspond to both ends of the insulating sheet member 70 and the insulating sheet member 80.

Further, sealing members 110 are made of a foamed elastic member and are brought into contact with the photosensitive drum 2 and the developing sleeve 4a and sealing members 100. The sealing members 110 are filled in a gap defined between the cover member 85 and the developing sleeve 4a in the side of both longitudinal ends of the developing sleeve 4a. With respect to the longitudinal position of the sealing members 110, they are disposed between the sealing member 90 and the insulating sheet member 80.

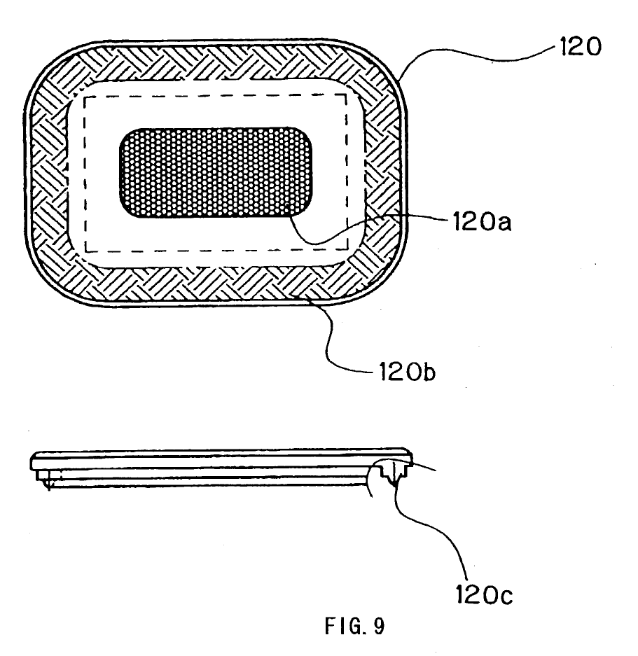

Subsequently, a filter member 120 is explained. As shown in FIG. 9, the filter member 120 is constituted of a resin member 120b and a filter 120a.

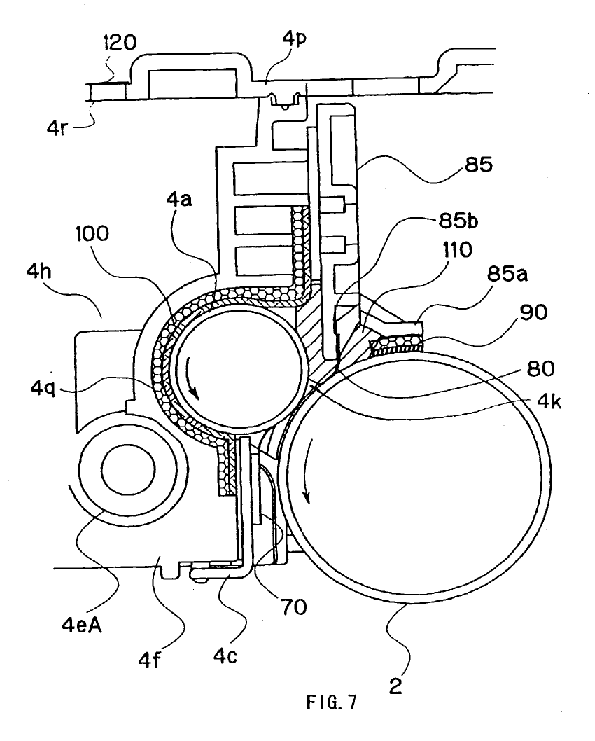

As shown in FIG. 7, the filter member 120 is fixed to a periphery of a vent port 4r of the developer containing portion 4h and covers the vent port 4r.

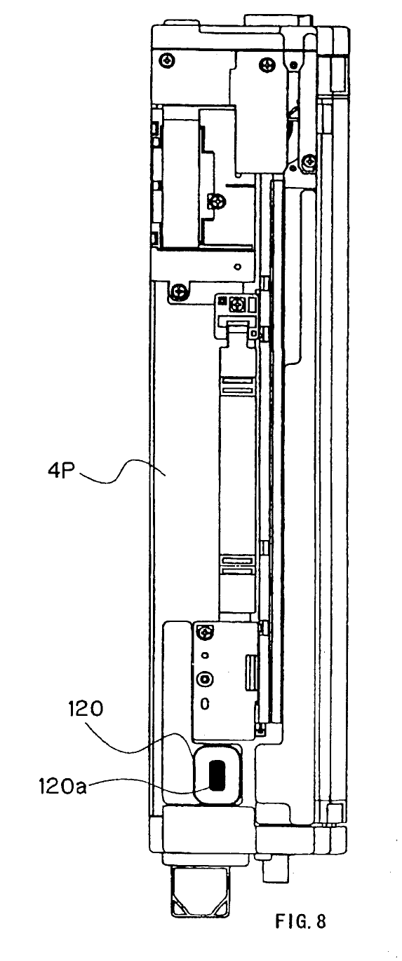

Further, a fused rib 120c is formed on the resin member 120b, wherein the fused rib 120c is fixedly mounted on a developing container lid 4p shown in FIG. 8 by ultrasonic welding.

As described above, by sealing both longitudinal ends of the developing sleeve 4a by means of the insulating sheet member 70, the insulating sheet members 80, the sealing members 90, the sealing members 100 and the sealing members 110, the occurrence of the air flow which may cause toner scattering can be interrupted. However, the inner pressure of the developer containing portion 4h is elevated. Accordingly, a vent port 4r is formed in the developer containing portion 4h.

The vent port 4r is covered with a filter 120a having a mesh which prevents the developer from passing through the filter 120a. That is, the filter 120a constitutes means which can prevent the elevation of inner pressure while preventing leaking of the toner and carrier from the vent port 4r.

As has been described heretofore, according to this embodiment, by sealing the opening portion of the developer containing portion including the developer bearing member using the sheet members and the sealing members, and at the same time, by adjusting the inner pressure of the developer containing portion while preventing leaking of the developer using the filter, it is possible to prevent scattering of the developer which may be caused by the air flow and to prevent smearing of the process cartridge and the inside of the image forming apparatus and the lowering of image quality. Further, it is also possible to prevent a user from being smeared when the user exchanges the cartridge.

As has been described heretofore, the present invention can obtain the advantageous effect that with the provision of the vent port, the sheet members and the sealing members, it is possible to prevent leaking of the developer from the developing device or the process cartridge by preventing the elevation of the inner pressure of the developer containing portion. Further, it is also possible to prevent leaking of the developer and scattering of the developer into the exposure optical path which is caused by leaking of the developer.

What is claimed is:

1. A developing device for developing a latent image formed on an electrophotographic photosensitive member used in an electrophotographic image forming apparatus, the developing device comprising:
a developing member for developing the latent image formed on the electrophotographic photosensitive member;
an exposure optical path for guiding an exposure light emitted from exposure means mounted in a body of the electrophotographic image forming apparatus to the electrophotographic photosensitive member;
a developer containing portion for containing a developer which is used by the developing member for developing the latent image;
a vent port for allowing air in the inside of the developer containing portion to pass therethrough;
a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member;
a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member; and
a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member.

2. A developing device according to claim 1, wherein the vent port is covered with a filter which prevents the developer from passing therethrough.

3. A developing device according to claim 2, wherein the filter is combined to a resin member and the resin member is welded to the developing device by ultrasonic welding.

4. A developing device according to claim 1, wherein the vent port is formed in an upper surface of the developer containing portion in a state that the developing device is mounted on a body of the electrophotographic image forming apparatus.

5. A developing device according to claim 1, wherein the developing device further includes
a layer thickness restricting member for restricting a layer thickness of the developer carried on a peripheral surface of the developing member to a given layer thickness, the layer thickness restricting member being arranged over the developing member with a given distance therebetween, and
a second sheet member for preventing the developer fallen from the developing member due to the layer thickness restricting member from leaking to the outside of the developing device, the second sheet member being mounted on the layer thickness restricting member and being in contact with the developing member.

6. A developing device according to claim 1, wherein the first sealing member is in contact with one end portion of the developing member along the longitudinal direction of the electrophotographic photosensitive member and the second sealing member is in contact with another end portion of the developing member along the longitudinal direction of the electrophotographic photosensitive member.

7. A developing device according to claim 1, wherein the first sheet member is made of a resin material and is formed in a sheet shape.

8. A developing device according to claim 1 or claim 6, wherein the first sealing member and the second sealing member are made of a foamed elastic member.

9. A developing device according to claim 7, wherein the first sheet member is made of polyurethane resin.

10. A process cartridge which is detachably attachable mounted on a body of an electrophotographic image forming apparatus, the process cartridge comprising:
an electrophotographic photosensitive member;
a developing member for developing the latent image formed on the electrophotographic photosensitive member;
an exposure optical path for guiding an exposure light emitted from exposure means mounted in a body of the electrophotographic image forming apparatus to the electrophotographic photosensitive member;
a developer containing portion for containing a developer which is used by the developing member for developing the latent image;
a vent port for allowing air in the inside of the developer containing portion to pass therethrough;
a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member;
a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member; and
a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member.

11. A process cartridge according to claim 10, wherein the vent port is covered with a filter which prevents the developer from passing therethrough.

12. A process cartridge according to claim 11, wherein the filter is combined to a resin member and the resin member is welded to the process cartridge by ultrasonic welding.

13. A process cartridge according to claim 10, wherein the vent port is formed in an upper surface of the developer containing portion in a state that the process cartridge is mounted on a body of the electrophotographic image forming apparatus.

14. A process cartridge according to claim 10, wherein the process cartridge further includes
a layer thickness restricting member for restricting a layer thickness of the developer carried on a peripheral surface of the developing member to a given thickness, the layer thickness restricting member being arranged over the developing member with a given distance therebetween, and
a second sheet member for preventing the developer fallen from the developer member due to the layer thickness restricting member from leaking to the outside of the developing device, the second sheet member being mounted on the layer thickness restricting member and being in contact with the developing member.

15. A process cartridge according to claim 10, wherein the first sealing member is in contact with one end portion of the developing member along the longitudinal direction of the electrophotographic photosensitive member and the second sealing member is in contact with another end portion of the developing member along the longitudinal direction of the electrophotographic photosensitive member.

16. A process cartridge according to claim 10, wherein the first sheet member is made of a resin material and is formed in a sheet shape.

17. A process cartridge according to claim 10 or claim 15, wherein the first sealing member and the second sealing member are made of a foamed elastic member.

18. A process cartridge according to claim 16, wherein the first sheet member is made of polyurethane resin.

19. An electrophotographic image forming apparatus for forming an image on a recording medium, the electrophotographic image forming apparatus comprising:
(a) exposure means;
(b) a developing device for developing a latent image formed on an electrophotographic photosensitive member used in the electrophotographic image forming apparatus, the developing device including a developing member for developing the latent image formed on the electrophotographic photosensitive member, an exposure optical path for guiding an exposure light emitted from exposure means mounted in a body of the electrophotographic image forming apparatus to the electrophotographic photosensitive member, a developer containing portion for containing a developer which is used by the developing member for developing the latent image, a vent port for allowing air in the inside of the developer containing portion to pass therethrough, a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member, a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member, and a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member; and
(c) conveying means for conveying the recording medium.

20. An electrophotographic image forming apparatus for forming an image on a recording medium on which a process cartridge can be detachably attachable mounted, the electrophotographic image forming apparatus comprising:
(a) exposure means;
(b) mounting means for detachably mounting the process cartridge which including an electrophotographic photosensitive member, a developing member for developing the latent image formed on the electrophotographic photosensitive member, an exposure optical path for guiding an exposure light emitted from exposure means mounted in a body of the electrophotographic image forming apparatus to the electrophotographic photosensitive member, a developer containing portion for containing a developer which is used by the developing member for developing the latent image, a vent port for allowing air in the inside of the developer containing portion to pass therethrough, a first sheet member for preventing scattering of the developer into the exposure optical path, the first sheet member being disposed between the exposure optical path and the developing member and being in contact with the electrophotographic photosensitive member in the longitudinal direction of the electrophotographic photosensitive member, a first sealing member for preventing leaking of the developer in the inside of the developer containing portion from the developer containing portion, the first sealing member being in contact with one end portion of the electrophotographic photosensitive member in the longitudinal direction of the electrophotographic photosensitive member, and a second sealing member for preventing leaking of the developer in the inside of the developer containing portion from the developer containing portion, the second sealing member being in contact with another end portion of the electrophotographic photosensitive member in the longitudinal direction of the electrophotographic photosensitive member; and
(c) conveying means for conveying the recording medium.
